(19) United States
(12) Patent Application Publication
(10) Pub. No.: US 2024/0320543 A1
(43) Pub. Date: Sep. 26, 2024

(54) Machine Learning Model Deployment in Inference System

(71) Applicant: International Business Machines Corporation, Armonk, NY (US)

(72) Inventors: Bo Song, Xi'an (CN); Dong Hai Yu, Xi'an (CN); Jun Wang, Xi'an (CN); Jiang Bo Kang, Xi'an (CN); Yao Dong Liu, Xi'an (CN); Xiao Ming Ma, Xi'an (CN)

(21) Appl. No.: 18/187,843

(22) Filed: Mar. 22, 2023

(51) Int. Cl. G06N 20/00; G06N 5/04

(52) U.S. Cl. CPC G06N 20/00; G06N 5/04

(57) ABSTRACT

Deploying machine learning models is provided. A new machine learning model is received for a given problem that corresponds to a service running in a container. A cluster of machine learning models of a plurality of clusters of machine learning models corresponding to the given problem is selected. A cluster performance score is determined for the cluster based on combining a model performance score of each machine learning model in the cluster in accordance with a corresponding weight of each machine learning model. It is determined whether the cluster performance score of the cluster is greater than a minimum cluster performance score threshold. The new machine learning model is added to the cluster to increase predictive accuracy for the given problem while the service is running without interruption in response to determining that the cluster performance score of the cluster is greater than the minimum cluster performance score threshold.

### BACKGROUND

The disclosure relates generally to machine learning models and more specifically to deploying machine learning models in running services without service interruption.

A machine learning model can learn without being explicitly programmed to do so. The machine learning model can learn based on a training dataset input into the machine learning model. The machine learning model can learn using various types of machine learning algorithms. The machine learning algorithms include at least one of supervised learning, semi-supervised learning, unsupervised learning, feature learning, sparse dictionary learning, association rules, or other types of learning algorithms. Examples of machine learning models can include an artificial neural network, convolutional neural network, regression neural network, decision tree, support vector machine, Bayesian network, and other types of models.

A validation dataset is independent of the training dataset for the machine learning model, but the validation dataset follows the same probability distribution as the training dataset. The validation dataset is a set of examples used only to assess the performance (e.g., the predictive accuracy) of the trained machine learning model. To assess model performance, the trained machine learning model is used to predict classifications of examples in the validation dataset. Those predicted classifications of the examples are compared to the examples' true classifications to assess the trained machine learning model's predictive accuracy.

### SUMMARY

According to one illustrative embodiment, a computer-implemented method for deploying machine learning models is provided. A computer receives a new machine learning model for a given problem that corresponds to a service running in a container of a host node and a new validation dataset corresponding to the new machine learning model. The computer selects a given cluster of machine learning models of a plurality of clusters of machine learning models corresponding to the given problem to form a selected cluster. The computer determines a cluster performance score for the selected cluster based on combining a model performance score of each respective machine learning model in the selected cluster in accordance with a corresponding weight of each respective machine learning model. The computer determines whether the cluster performance score of the selected cluster is greater than a predefined minimum cluster performance score threshold level. The computer adds the new machine learning model to the selected cluster to increase predictive accuracy for the given problem while the service is running in the container of the host node without interruption of the service in response to the computer determining that the cluster performance score of the selected cluster is greater than the predefined minimum cluster performance score threshold level. According to other illustrative embodiments, a computer system and computer program product for deploying machine learning models are provided.

### BRIEF DESCRIPTION OF THE DRAWINGS

FIG. 1 is a pictorial representation of a computing environment in which illustrative embodiments may be implemented;

FIG. 2 is a diagram illustrating an example of a machine learning model deployment process in accordance with an illustrative embodiment;

FIG. 3 is a diagram illustrating an example of a data record prediction process in accordance with an illustrative embodiment;

FIGS. 4A-4E are a flowchart illustrating a process for deploying machine learning models in running services in accordance with an illustrative embodiment; and

FIG. 5 is a flowchart illustrating a process for outputting predictions for input data records corresponding to given problems in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

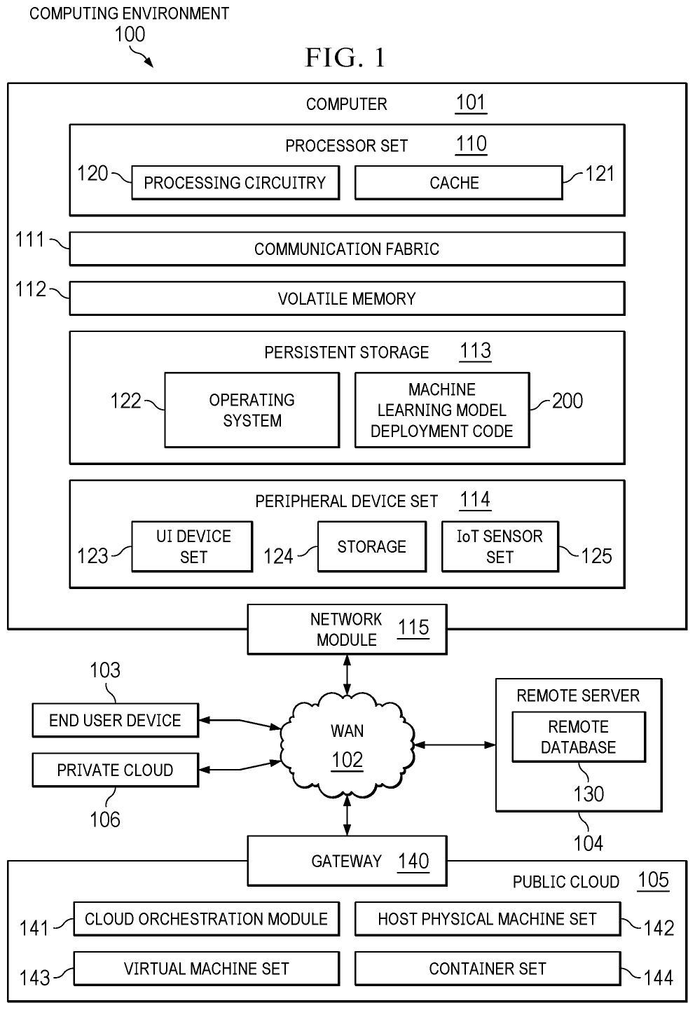

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as machine learning model deployment code 200. For example, machine learning model deployment code 200 manages and controls the deployment of different types of machine learning models in running services without service interruption.

In addition to machine learning model deployment code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and machine learning model deployment code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in machine learning model deployment code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The machine learning model deployment code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a user of the machine learning model deployment services provided by computer 101), and may take any of the forms discussed above in connection with computer 101. EUD 103 typically receives helpful and useful data from the operations of computer 101. For example, in a hypothetical case where computer 101 is designed to provide a machine learning model deployment recommendation to the end user, this machine learning model deployment recommendation would typically be communicated from network module 115 of computer 101 through WAN 102 to EUD 103. In this way, EUD 103 can display, or otherwise present, the machine learning model deployment recommendation to the end user. In some embodiments, EUD 103 may be a client device, such as thin client, heavy client, mainframe computer, desktop computer, laptop computer, tablet computer, smartphone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a machine learning model deployment recommendation based on historical machine learning model deployment data, then this historical machine learning model deployment data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

For a given problem (e.g., credit card deception), typically a variety of different frameworks and machine learning model algorithms are used to discover pattens corresponding to that particular problem. For example, classical machine learning models, such as logistic regression, decision tree, support vector machine, and the like, deep machine learning models such as convolutional neural network, recurrent neural network, and the like, and ensemble machine learning models such as random forest, extreme gradient boosting, light-gradient boosting machine, and the like can be used to discover these patterns. Currently, ensemble machine learning models are widely used and considered to be an effective way to achieve better overall predictive results rather than just using only one individual machine learning model.

Generally, different types of machine learning models run in different environments. How to combine these different types of machine learning models that run in different environments into an ensemble machine learning model for deployment is a challenge. In addition, problem analysis involves frequent iterations. For example, as newer data is being received, new machine learning models need to be built and trained to maintain prediction performance (e.g., accuracy) for given problems. How to combine these new machine learning models with previously deployed older machine leaning models or replace previously deployed older machine leaning models with these new machine learning models, without interruption of the service corresponding to the problem (e.g., credit card deception), also is a challenge.

Current solutions mainly focus on building machine learning models. For example, current solutions generate an ensemble machine learning model, which contains several machine learning models of the same type, using a standard format, such as, for example, a predictive model markup language format or an open neural network exchange format. An issue with current solutions generating an ensemble machine learning model using a standard format, such as a predictive model markup language format or an open neural network exchange format, is that current solutions cannot generate an ensemble machine learning model that contains different types of machine learning models because not all machine learning model types are supported by these standard formats. As a result, current solutions, using these standard formats, would find it difficult to combine a classical machine learning model with a deep machine learning model to generate an ensemble machine learning model. Furthermore, current solutions cannot deploy an ensemble machine learning model or several machine learning models into a running service to update the service without interruption of that service.

Illustrative embodiments build a self-learning inference system to combine a plurality of machine learning models of different types into an ensemble machine learning model having increased predictive accuracy for deployment into a running service. In other words, illustrative embodiments deploy multiple machine learning models for a single problem at the same time, without regard for the type or source of each respective machine learning model. Illustrative embodiments combine predictive results of a group of machine learning models in a cluster (i.e., an ensemble machine learning model) to produce a more accurate prediction. For example, illustrative embodiments utilize a clustering algorithm to automatically assemble a plurality of machine learning models into a plurality of machine learning model clusters. Illustrative embodiments then select a predefined number of clusters, which are most similar to an input data record having input values for all input fields corresponding to the given problem, from the plurality of machine learning model clusters. Illustrative embodiments then utilize a prediction of a cluster of the predefined number of clusters that has a highest prediction confidence score as a final prediction for the classification of that input data record.

Illustrative embodiments utilize the self-learning inference system, without human involvement, to automatically adjust the clusters of machine learning models as illustrative embodiments deploy new machine learning models to the service corresponding to the given problem and remove previously deployed older machine learning models. Illustrative embodiments dynamically and seamlessly add and remove machine learning models without interruption of that service.

In response to receiving an input data record having all values for all input fields corresponding to a given problem associated with a service from a client device via a network, illustrative embodiments traverse all of the plurality of machine learning model clusters and determine a distance between the input data record and a center of a validation dataset of each respective cluster of machine learning models of the plurality of machine learning model clusters. The distance determines an amount of similarity between the input data record and a validation dataset of a particular cluster. In other words, a shorter distance equals greater similarity between the input data record and a validation dataset of a particular cluster, whereas a greater distance equals decreased similarity. After illustrative embodiments determine the distance between the input data record and the center of the validation dataset of each respective cluster of machine learning models, illustrative embodiments select the top predefined number of machine learning model clusters having the shortest distance between the input data record and the center of its corresponding validation dataset. In other words, the top predefined number of machine learning model clusters is most similar, alike, or comparable to the input data record. The top predefined number of machine learning model clusters is, for example, three (3) by default.

Each cluster contains multiple machine learning models of different types. Each machine learning model in a cluster has an assigned weight (e.g., weight=1.0 by default). A machine learning model having a higher weight in a cluster will have greater influence in the overall prediction of that particular cluster, whereas a machine learning model having a lower weight in a cluster will have lesser influence in the overall prediction of that particular cluster. Illustrative embodiments determine the overall prediction of a cluster for the input data record corresponding to the given problem based on combining the predictive output of each respective machine learning model in the cluster in accordance with its associated weight. For regression machine learning models, illustrative embodiments can utilize, for example, weighted average, weighted median, or the like, to determine the overall prediction of a cluster. For classical machine learning models, in addition to the methods mentioned above, illustrative embodiments can also utilize, for example, weighted majority vote, or the like.

Moreover, illustrative embodiments determine a prediction confidence score for each overall prediction corresponding to each respective cluster of machine learning models. Afterward, illustrative embodiments utilize as a final prediction for the input data record corresponding to the given problem, the overall prediction of the cluster of machine learning models having the highest prediction confidence score. In other words, the final prediction for the classification of the input data record corresponding to the given problem associated with the service is based on the predictive result of the machine learning model cluster having the highest prediction confidence score.

Illustrative embodiments receive a new machine learning model to deploy in a running service, along with a new validation dataset corresponding to the new machine learning model. Illustrative embodiments retrieve a set of parameters of the self-learning inference system. The set of parameters include, for example, a predefined maximum number of clusters (“C”) in the self-learning inference system and a predefined maximum number of machine learning models (“M”) in a single cluster of machine learning models. In addition, illustrative embodiments compute a coefficient value for each respective cluster of machine learning models using the following equation:

$${F}_{i} = {P}_{i} * ( {C}_{i} / C ) ,$$

where “Fᵢ” is the coefficient value for a particular cluster (e.g., the i-th cluster), “Pᵢ” equals the predictive performance of that particular cluster, “Cᵢ” equals the number of machine learning models in that particular cluster, and C, as noted above, equals the predefined maximum number of clusters for the self-learning inference system.

Illustrative embodiments sort the plurality of machine learning model clusters in descending order by corresponding coefficient value. In other words, illustrative embodiments list the plurality of machine learning model clusters from lowest coefficient cluster at the top of the list to the highest coefficient cluster at the bottom of the list. Illustrative embodiments traverse the plurality of machine learning model clusters in descending order because the machine learning model cluster having the lowest coefficient value needs updating the most, the machine learning model cluster having the second lowest coefficient value needs updating next, and so on. In other words, a low coefficient cluster needs updating first with a new machine learning model, which has a model predictive accuracy performance greater than a predefined minimum model predictive accuracy performance threshold level, to increase the overall predictive accuracy of that particular low coefficient cluster.

Illustrative embodiments determine whether illustrative embodiments can add the new machine learning model to a given cluster of machine learning models without removing another previously deployed machine learning model from that cluster. If illustrative embodiments determine that the predictive performance of the new machine learning model is greater than the predefined minimum model predictive performance threshold level and the number of models in the cluster is less than the predefined maximum number of models in a single cluster, then illustrative embodiments add the new machine learning model to that cluster and skip remaining clusters because the model adding job is finished. Conversely, if illustrative embodiments determine that the predictive performance of the new machine learning model is less than or equal to the predefined minimum model predictive performance threshold level or the number of models in the cluster is equal to the predefined maximum number of models in a single cluster, then illustrative embodiments do not add the new machine learning model to that cluster and continue checking remaining clusters. Alternatively, if illustrative embodiments determine that the predictive performance of the new machine learning model is greater than the predefined minimum model predictive performance threshold level but the number of models in the cluster is equal to the predefined maximum number of models in a single cluster, then illustrative embodiments do not add the new machine learning model to that cluster, but instead generate a new cluster to take the new machine learning model if the maximum number of clusters has not been reached. In other words, if illustrative embodiments determine that none of the clusters can add the new machine learning model, then illustrative embodiments add a new cluster to include the new machine learning model if its predictive performance is greater than the predefined minimum model predictive performance threshold level.

This is an example of how illustrative embodiments determine when to add a new machine learning model to a particular cluster of machine learning models. Illustrative embodiments perform this model addition process for each individual cluster of machine learning models for a given problem corresponding to a service. First, illustrative embodiments select a given cluster of machine learning models. Then, illustrative embodiments combine the new validation dataset, which corresponds to the new machine learning model, with the current validation dataset corresponding to the selected cluster, to form a combined validation dataset for the selected cluster.

Afterward, illustrative embodiments determine the total number of data records in the combined validation dataset for the selected cluster. If illustrative embodiments determine that the total number of data records in the combined validation dataset for the selected cluster is greater than a predefined maximum number of data records for a single cluster, then illustrative embodiments sample the total number of data records in the combined validation dataset to reduce the total number of data records in the combined validation dataset for the selected cluster down to a user-specified number of data records. Further, illustrative embodiments calculate a model predictive performance score for each respective machine learning model in the selected cluster using the combined validation dataset based on a set of predefined model evaluation metrics. The set of predefined model evaluation metrics includes, for example, at least one of accuracy, sensitivity, specificity, variance, or the like.

Subsequently, illustrative embodiments determine whether the number of machine learning models in the selected cluster is equal to the predefined maximum number of models for a single cluster. If illustrative embodiments determine that the number of machine learning models in the selected cluster is less than the predefined maximum number of models for a single cluster, then illustrative embodiments calculate a cluster predictive performance score for the selected cluster based on combining the calculated model predictive performance score of each respective machine learning model in the selected cluster in accordance with its corresponding weight. If illustrative embodiments determine that the cluster predictive performance score of the selected cluster is greater than a predefined minimum cluster predictive performance score threshold level (e.g., 0.95 by default), then illustrative embodiments add the new machine learning model to the selected cluster while the service is running in a container of a host node without interruption of the service. If illustrative embodiments determine that the cluster predictive performance score of the selected cluster is less than or equal to the predefined minimum cluster predictive performance threshold level, then illustrative embodiments return the new machine learning model, along with the new validation dataset, to the beginning of the model addition process and select another cluster to determine whether that cluster can add the new machine learning model.

Alternatively, if illustrative embodiments determined that the number of machine learning models in the selected cluster is equal to the predefined maximum number of models for a single cluster, then illustrative embodiments select a machine learning model in the selected cluster that has the lowest calculated model predictive performance score (i.e., the worst performing machine learning model in the cluster). Afterward, illustrative embodiments determine whether the machine learning model having the lowest calculated model predictive performance score is the new machine learning model. If illustrative embodiments determine that the machine learning model having the lowest calculated model predictive performance score is the new machine learning model, then illustrative embodiments determine that the selected cluster cannot add the new machine learning model and return the new machine learning model, along with the new validation dataset, to the beginning of the model addition process to select another cluster to determine whether that cluster can add the new machine learning model. If illustrative embodiments determine that the machine learning model having the lowest calculated model predictive performance score is not the new machine learning model, then illustrative embodiments calculate a cluster predictive performance score for the selected cluster based on combining the calculated model predictive performance score of each respective machine learning model in the selected cluster in accordance with its corresponding weight.

If illustrative embodiments determine that the calculated cluster predictive performance score for the selected cluster is less than or equal to the predefined minimum cluster predictive performance threshold level, then illustrative embodiments do not add the new machine learning model to the selected cluster and return the new machine learning model, along with the new validation dataset, to the beginning of the model addition process to select another cluster to determine whether that cluster can add the new machine learning model. If illustrative embodiments determine that the calculated cluster predictive performance score for the selected cluster is greater than the predefined minimum cluster predictive performance threshold level, then illustrative embodiments add the new machine learning model to the selected cluster while the service is running in a container of a host node without interruption of the service.

Furthermore, illustrative embodiments replace the validation dataset corresponding to the selected cluster with the combined validation dataset. Moreover, illustrative embodiments recalculate the weight of each respective machine learning model in the selected cluster based on the combined validation dataset. Illustrative embodiments recalculate the weight of machine learning models utilizing, for example, exhaustive grid search weight scoring values between 0 and 1, an optimization procedure such as a linear solver, or gradient descent optimization, or the like. Further, illustrative embodiments remove the machine learning model having the lowest calculated model performance score from the selected cluster because adding the new machine learning model to the selected cluster caused the number of machine learning models in the selected cluster to exceed the maximum number of machine learning models for a single cluster of machine learning models. After removing the machine learning model having the lowest calculated model performance score from the selected cluster, illustrative embodiments return the removed machine learning model, along with the original validation dataset corresponding to the removed machine learning model, to the beginning of the model addition process to select another cluster to determine whether that cluster can add the removed machine learning model.

If illustrative embodiments determine that a remaining machine learning model exists after performing the model addition process for all of the clusters of machine learning models (i.e., illustrative embodiments were not able to add the remaining machine learning model, which can be the new machine learning model or an older previously deployed machine learning model that was removed from a cluster, to any of the clusters), illustrative embodiments determine the total number of clusters. If illustrative embodiments determine that the total number of clusters is less than the predefined maximum number of clusters and the model predictive performance score of the remaining machine learning model is greater than the predefined minimum model predictive performance score threshold level (e.g., 0.95 by default) based on the validation dataset corresponding to the remaining machine learning model, then illustrative embodiments add a new cluster, add the remaining machine learning model to the new cluster, and assign a default weight of 1.0 to the remaining machine learning model in the new cluster. If illustrative embodiments determine that the total number of clusters is equal to the predefined maximum number of clusters or the model predictive performance score of the remaining machine learning model is less than or equal to the predefined minimum model predictive performance score threshold level based on the validation dataset corresponding to the remaining machine learning model, then illustrative embodiments send an alert to a user (e.g., system administrator, program developer, owner of the remaining machine learning model, or the like) regarding the remaining machine learning model indicating one of a warning when the remaining machine learning model is the removed machine learning model because its model performance score is less than the new machine learning model and the predefined maximum number of machine learning model clusters has been reached or an error when the remaining machine learning model is the new machine learning model because its model performance score is less than any existing machine learning model and the predefined maximum number of machine learning model clusters has been reached.

Thus, illustrative embodiments are capable of deploying multiple machine learning models for a single problem at the same time without regard for the type or source of the machine learning models. In addition, illustrative embodiments are capable of automatically adjusting the clusters of machine learning models as new machine learning models are received. Further, illustrative embodiments are capable of dynamically and seamlessly adding and removing machine learning models from clusters without service interruption.

Thus, illustrative embodiments provide one or more technical solutions that overcome a technical problem with deploying machine learning models of different types for a given problem without causing service interruption. As a result, these one or more technical solutions provide a technical effect and practical application in the field of machine learning models.

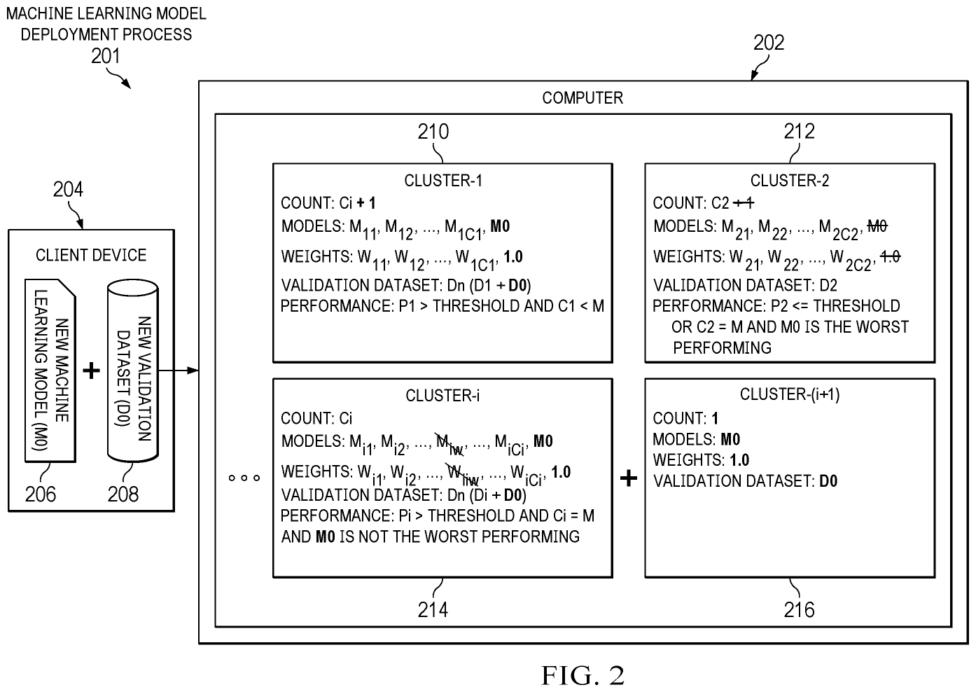

With reference now to FIG. 2, a diagram illustrating an example of a machine learning model deployment process is depicted in accordance with an illustrative embodiment. Machine learning model deployment process 201 may be implemented in a computing environment, such as computing environment 100 in FIG. 1. Machine learning model deployment process 201 includes the hardware and software components for managing the deployment of new machine learning models.

In this example, machine learning model deployment process 201 includes computer 202 and client device 204. Computer 202 and client device 204 may be, for example, computer 101 and EUD 103 in FIG. 1. However, it should be noted that machine learning model deployment process 201 is intended as an example only and not as a limitation on illustrative embodiments. For example, machine learning model deployment process 201 can include any number of computers, client devices, and other devices and components not shown.

Client device 204 sends new machine learning model 206, along with new validation dataset 208 that corresponds to new machine learning model 206, to computer 202 via a network, such as, for example, WAN 102. New machine learning model 206 corresponds to a given problem (e.g., identity deception or the like) associated with a service (e.g., a banking service, financial service, healthcare service, government service, educational service, or the like).

In this example, computer 202 can add new machine learning model 206 to cluster-1 210 because predictive performance of cluster-1 210 is greater than the cluster predictive performance threshold and the number of machine learning models (“C1”) in cluster-1 210 is less than the predefined maximum number of machine learning models (“M”) for a single cluster. Conversely, computer 202 cannot add new machine learning model 206 to cluster-2 212 because the predictive performance of cluster-2 212 is less than or equal to the cluster predictive performance threshold or the number of machine learning models (“C2”) in cluster-2 212 is equal to the predefined maximum number of machine learning models for a single cluster and new machine learning model 206 is determined to be the worst performing model in cluster-2 212.

However, even though the number of machine learning models (“Ci”) in cluster-i 214 is equal to the predefined maximum number of machine learning models for a single cluster, computer 202 can add new machine learning model 206 to cluster-i 214 because the predictive performance of cluster-i 214 is greater than the predictive performance threshold and new machine learning model 206 is not the worst performing machine learning model in cluster-i 214. In this case, computer 202 determined that machine learning model “Mw” is the worst performing machine learning model in cluster-i 214. Since the number of machine learning models (“Ci”) in cluster-i 214 is already equal to the predefined maximum number of machine learning models, computer 202 removes worst performing machine learning model “Mw” so computer 202 can add new machine learning model 206 to cluster-i 214 to increase the predictive accuracy of cluster-i 214. Alternatively, if computer 202 determines that the performance of new machine learning model 206 is greater than a predefined minimum model performance threshold, then computer 202 can add new cluster-(i+1) 216 and add new machine learning model 206 to new cluster-(i+1) 216. In this alternative case where computer 202 adds new machine learning model 206 to new cluster-(i+1) 216 instead of cluster-i 214, computer 202 does not remove worst performing machine learning model “Mw” from cluster-i 214 because the predictive performance of cluster-i 214 is greater than the cluster predictive performance threshold.

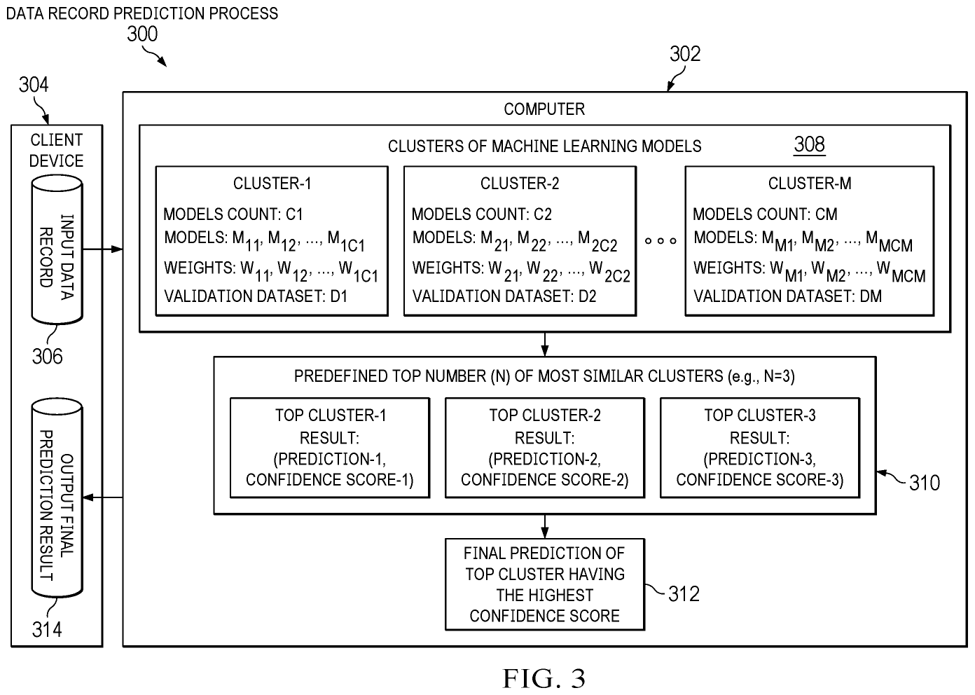

With reference now to FIG. 3, a diagram illustrating an example of a data record prediction process is depicted in accordance with an illustrative embodiment. Data record prediction process 300 may be implemented in a computing environment, such as computing environment 100 in FIG. 1.

In this example, data record prediction process 300 includes computer 302 and client device 304. Computer 302 may be, for example, computer 101 in FIG. 1. Client device 304 may be, for example, a host node in one of host physical machine set 142, virtual machine set 143, or container set 144 in FIG. 1. However, it should be noted that data record prediction process 300 is intended as an example only and not as a limitation on illustrative embodiments. For example, data record prediction process 300 can include any number of computers, client devices, and other devices and components not shown.

Client device 304 sends input data record 306, which contains all values for all input fields corresponding to a given problem associated with a service, to computer 302 to predict the classification (e.g., deception, not deception) of input data record 306 for the given problem. Computer 302 includes clusters of machine learning models 308 (e.g., cluster-1, cluster-2, . . . to cluster-M), which correspond to the given problem. Computer 302 determines predefined top number of most similar clusters 310 (e.g., top cluster-1, top cluster-2, and top cluster-3) by calculating the distance between input data record 306 and the center of each validation dataset (e.g., D1, D2, . . . to DM) of each respective cluster of clusters of machine learning models 308. Predefined top number of most similar clusters 310 have the shortest distances between input data record 306 and the center of their respective validation dataset. In other words, predefined top number of most similar clusters 310 are closest to input data record 306.

Further, computer 302 generates a prediction confidence score for each cluster in predefined top number of most similar clusters 310. Then, computer 302 selects the top cluster having the highest prediction confidence score. At 312, computer 302 utilizes the prediction of the top cluster having the highest prediction confidence score as the final prediction for input data record 306. At 314, computer 302 outputs the final prediction result for input data record 306 to client device 304 via the network.

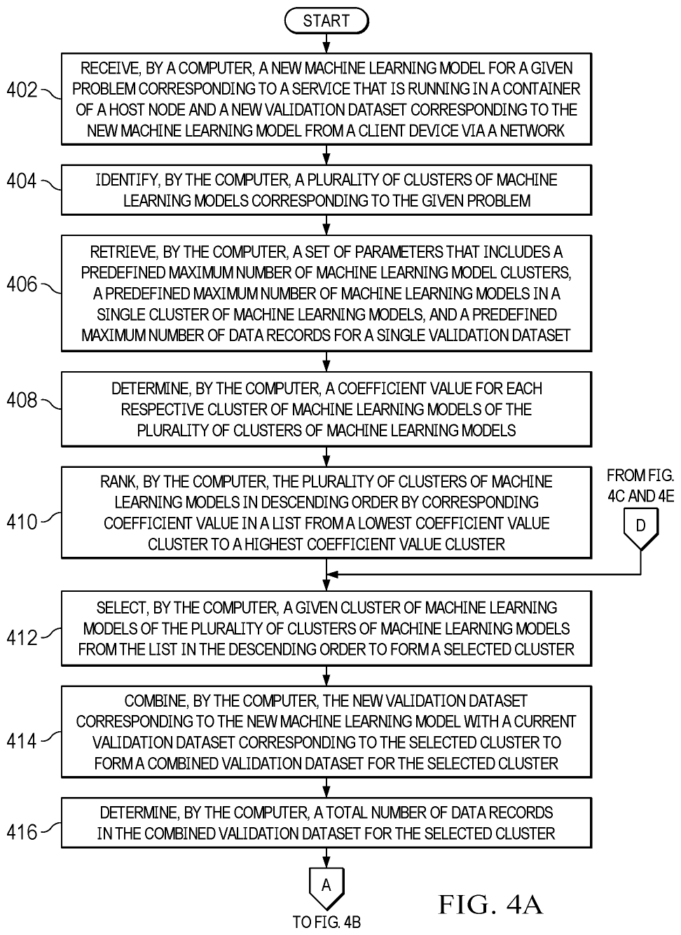

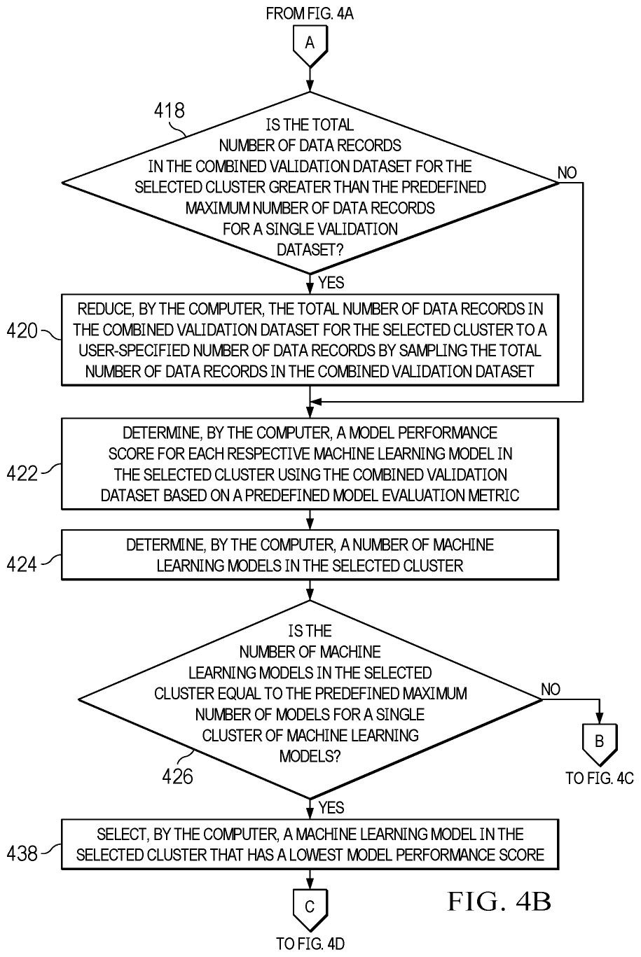

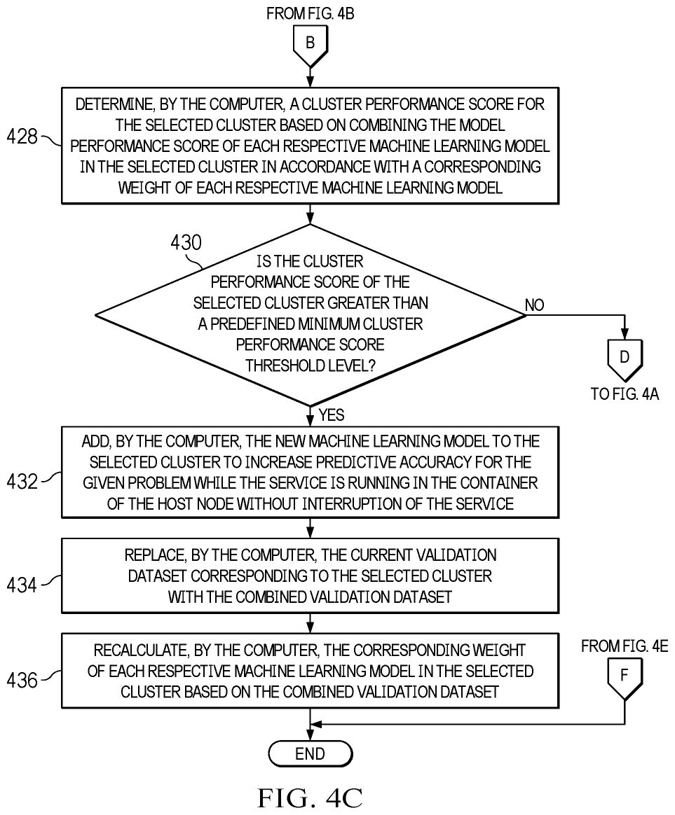

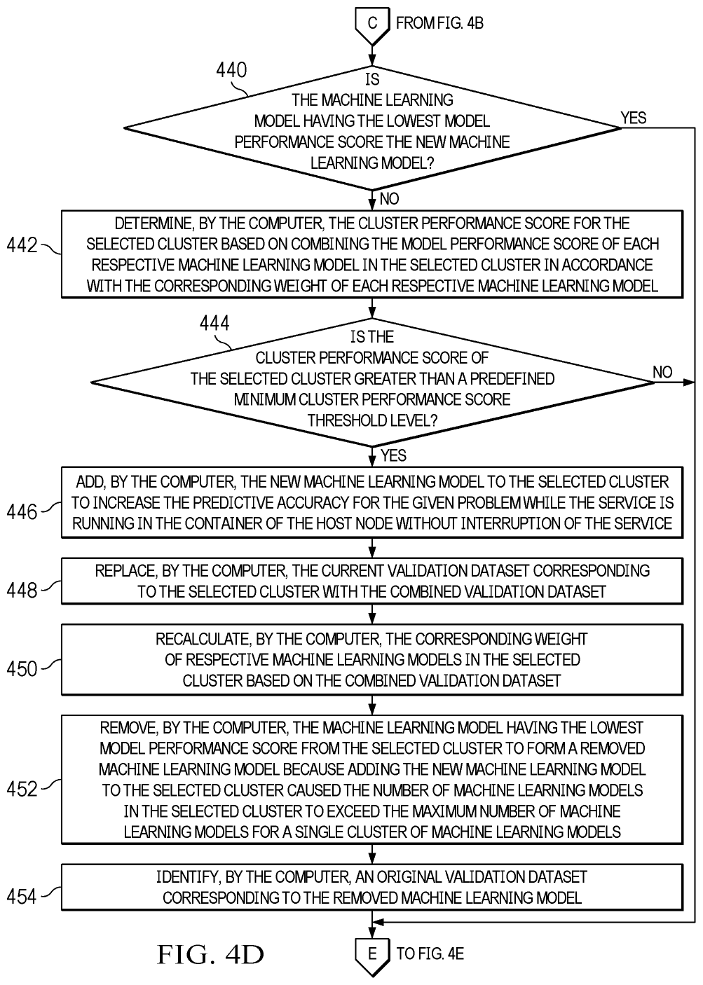

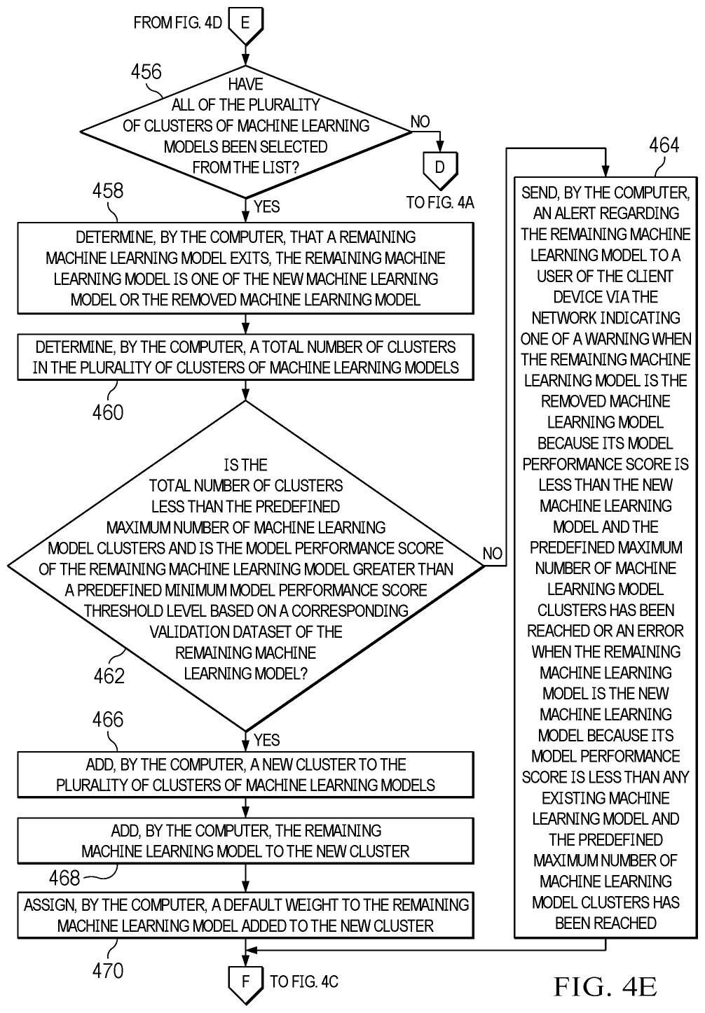

With reference now to FIGS. 4A-4E, a flowchart illustrating a process for deploying machine learning models in running services is shown in accordance with an illustrative embodiment. The process shown in FIGS. 4A-4E may be implemented in a computer, such as, for example, computer 101 in FIG. 1. For example, the process shown in FIGS. 4A-4E may be implemented in machine learning model deployment code 200 in FIG. 1.

The process begins when the computer receives a new machine learning model for a given problem corresponding to a service that is running in a container of a host node and a new validation dataset corresponding to the new machine learning model from a client device via a network (step 402). In response to the computer receiving the new machine learning model for the given problem, the computer identifies a plurality of clusters of machine learning models corresponding to the given problem (step 404). In addition, the computer retrieves a set of parameters that includes a predefined maximum number of machine learning model clusters, a predefined maximum number of machine learning models in a single cluster of machine learning models, and a predefined maximum number of data records for a single validation dataset (step 406).

Further, the computer determines a coefficient value for each respective cluster of machine learning models of the plurality of clusters of machine learning models (step 408). The computer ranks the plurality of clusters of machine learning models in descending order by corresponding coefficient value in a list from a lowest coefficient value cluster to a highest coefficient value cluster (step 410).

The computer selects a given cluster of machine learning models of the plurality of clusters of machine learning models from the list in the descending order to form a selected cluster (step 412). The computer combines the new validation dataset corresponding to the new machine learning model with a current validation dataset corresponding to the selected cluster to form a combined validation dataset for the selected cluster (step 414). Afterward, the computer determines a total number of data records in the combined validation dataset for the selected cluster (step 416).

The computer makes a determination as to whether the total number of data records in the combined validation dataset for the selected cluster is greater than the predefined maximum number of data records for a single validation dataset (step 418). If the computer determines that the total number of data records in the combined validation dataset for the selected cluster is greater than the predefined maximum number of data records for a single validation dataset, yes output of step 418, then the computer reduces the total number of data records in the combined validation dataset for the selected cluster to a user-specified number of data records by sampling the total number of data records in the combined validation dataset (step 420). Thereafter, the process proceeds to step 422. If the computer determines that the total number of data records in the combined validation dataset for the selected cluster is not greater than the predefined maximum number of data records for a single validation dataset, no output of step 418, then the computer determines a model performance score for each respective machine learning model in the selected cluster using the combined validation dataset based on a predefined model evaluation metric (step 422). It should be noted that the user can select the predefined model evaluation metric from a plurality of predefined model evaluation metric options based on the type of the given problem. Moreover, the computer determines a number of machine learning models in the selected cluster (step 424).

The computer makes a determination as to whether the number of machine learning models in the selected cluster is equal to the predefined maximum number of models for a single cluster of machine learning models (step 426). If the computer determines that the number of machine learning models in the selected cluster is not equal to (i.e., is less than) the predefined maximum number of models for a single cluster of machine learning models, no output of step 426, then the computer determines a cluster performance score for the selected cluster based on combining the model performance score of each respective machine learning model in the selected cluster in accordance with a corresponding weight of each respective machine learning model (step 428).

The computer makes a determination as to whether the cluster performance score of the selected cluster is greater than a predefined minimum cluster performance score threshold level (step 430). If the computer determines that the cluster performance score of the selected cluster is not greater than the predefined minimum cluster performance score threshold level, no output of step 430, then the process returns to step 412 where the computer selects another cluster of machine learning models from the plurality of clusters of machine learning models from the list in descending order. If the computer determines that the cluster performance score of the selected cluster is greater than the predefined minimum cluster performance score threshold level, yes output of step 430, then the computer adds the new machine learning model to the selected cluster to increase predictive accuracy for the given problem while the service is running in the container of the host node without interruption of the service (step 432). The computer also replaces the current validation dataset corresponding to the selected cluster with the combined validation dataset (step 434). In addition, the computer recalculates the corresponding weight of each respective machine learning model in the selected cluster based on the combined validation dataset (step 436). Thereafter, the process terminates.

Returning again to step 426, if the computer determines that the number of machine learning models in the selected cluster is equal to the predefined maximum number of models for a single cluster of machine learning models, yes output of step 426, then the computer selects a machine learning model in the selected cluster that has a lowest model performance score (step 438). Then, the computer makes a determination as to whether the machine learning model having the lowest model performance score is the new machine learning model (step 440). If the computer determines that the machine learning model having the lowest model performance score is the new machine learning model, yes output of step 440, then the process returns to step 412 where the computer selects another cluster of machine learning models from the plurality of clusters of machine learning models from the list in descending order. If the computer determines that the machine learning model having the lowest model performance score is not the new machine learning model, no output of step 440, then the computer determines the cluster performance score for the selected cluster based on combining the model performance score of each respective machine learning model in the selected cluster in accordance with the corresponding weight of each respective machine learning model (step 442).

Subsequently, the computer makes a determination as to whether the cluster performance score of the selected cluster is greater than the predefined minimum cluster performance score threshold level (step 444). If the computer determines that the cluster performance score of the selected cluster is not greater than the predefined minimum cluster performance score threshold level, no output of step 444, then the process returns to step 412 where the computer selects another cluster of machine learning models from the plurality of clusters of machine learning models from the list in descending order. If the computer determines that the cluster performance score of the selected cluster is greater than the predefined minimum cluster performance score threshold level, yes output of step 444, then the computer adds the new machine learning model to the selected cluster to increase the predictive accuracy for the given problem while the service is running in the container of the host node without interruption of the service (step 446). In addition, the computer replaces the current validation dataset corresponding to the selected cluster with the combined validation dataset (step 448). Further, the computer recalculates the corresponding weight of respective machine learning models in the selected cluster based on the combined validation dataset (step 450).

Moreover, the computer removes the machine learning model having the lowest model performance score from the selected cluster to form a removed machine learning model because adding the new machine learning model to the selected cluster caused the number of machine learning models in the selected cluster to exceed the maximum number of machine learning models for a single cluster of machine learning models (step 452). The computer also identifies an original validation dataset corresponding to the removed machine learning model (step 454).

Afterward, the computer makes a determination as to whether all of the plurality of clusters of machine learning models have been selected from the list (step 456). If the computer determines that not all of the plurality of clusters of machine learning models have been selected from the list, no output of step 456, then the process returns to step 412 where the computer selects another cluster of machine learning models from the plurality of clusters of machine learning models from the list in descending order. It should be noted that after selecting another cluster in step 412 based on the no output of step 456, the computer combines either the original validation dataset corresponding to the removed machine learning model or the new validation dataset corresponding to the new machine learning model with the current validation dataset of the selected cluster to form the combined validation dataset for the selected cluster in step 414 depending on whether the removed machine learning model or the new machine learning model is returned.

If the computer determines that all of the plurality of clusters of machine learning models have been selected from the list, yes output of step 456, then the computer determines that a remaining machine learning model exits (step 458). The remaining machine learning model is one of the new machine learning model or the removed machine learning model. In addition, the computer determines a total number of clusters in the plurality of clusters of machine learning models (step 460).

Afterward, the computer makes a determination as to whether the total number of clusters is less than the predefined maximum number of machine learning model clusters and the model performance score of the remaining machine learning model is greater than a predefined minimum model performance score threshold level based on a corresponding validation dataset of the remaining machine learning model (step 462). If the computer determines that either the total number of clusters is not less than the predefined maximum number of machine learning model clusters or the model performance score of the remaining machine learning model is not greater than the predefined minimum model performance score threshold level based on the corresponding validation dataset of the remaining machine learning model, no output of step 462, then the computer sends an alert regarding the remaining machine learning model to a user of the client device via the network indicating one of a warning when the remaining machine learning model is the removed machine learning model because its model performance score is less than the new machine learning model and the predefined maximum number of machine learning model clusters has been reached or an error when the remaining machine learning model is the new machine learning model because its model performance score is less than any existing machine learning model and the predefined maximum number of machine learning model clusters has been reached (step 464). Thereafter, the process terminates.

If the computer determines that the total number of clusters is less than the predefined maximum number of machine learning model clusters and the model performance score of the remaining machine learning model is greater than the predefined minimum model performance score threshold level based on the corresponding validation dataset of the remaining machine learning model, yes output of step 462, then the computer adds a new cluster to the plurality of clusters of machine learning models (step 466). Furthermore, the computer adds the remaining machine learning model to the new cluster (step 468). Moreover, the computer assigns a default weight to the remaining machine learning model added to the new cluster (step 470). Thereafter, the process terminates.

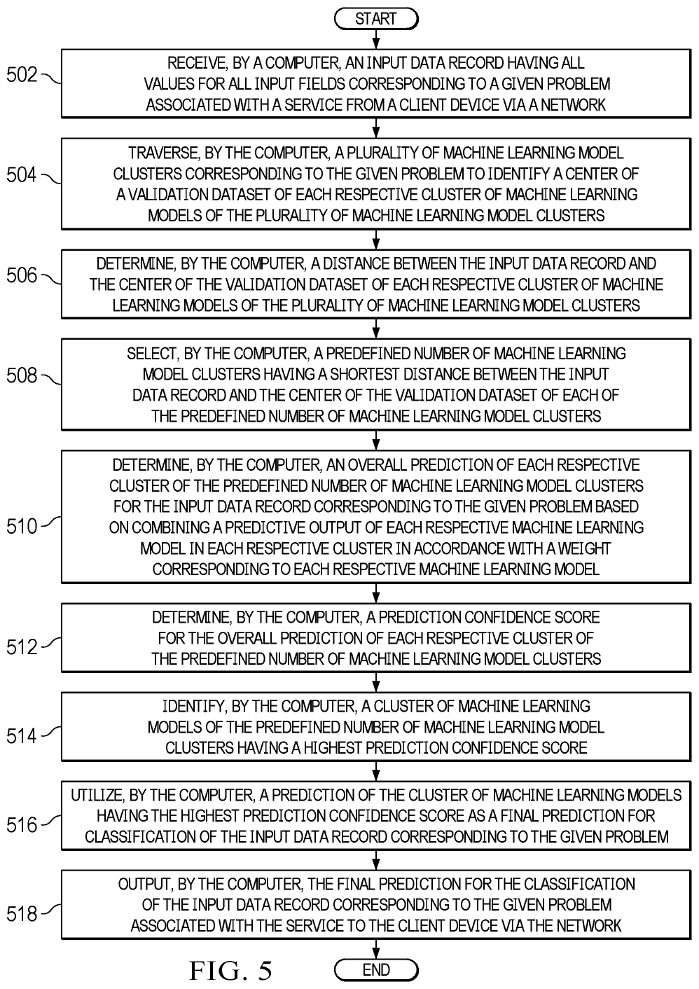

With reference now to FIG. 5, a flowchart illustrating a process for outputting predictions for input data records corresponding to given problems is shown in accordance with an illustrative embodiment. The process shown in FIG. 5 may be implemented in a computer, such as, for example, computer 101 in FIG. 1. For example, the process shown in FIG. 5 may be implemented in machine learning model deployment code 200 in FIG. 1.

The process begins when the computer receives an input data record having all values for all input fields corresponding to a given problem associated with a service from a client device via a network (step 502). In response to the computer receiving the input data record, the computer traverses a plurality of machine learning model clusters corresponding to the given problem to identify a center of a validation dataset of each respective cluster of machine learning models of the plurality of machine learning model clusters (step 504). In addition, the computer determines a distance between the input data record and the center of the validation dataset of each respective cluster of machine learning models of the plurality of machine learning model clusters (step 506).

The computer selects a predefined number of machine learning model clusters having a shortest distance between the input data record and the center of the validation dataset of each of the predefined number of machine learning model clusters (step 508). Further, the computer determines an overall prediction of each respective cluster of the predefined number of machine learning model clusters for the input data record corresponding to the given problem based on combining a predictive output of each respective machine learning model in each respective cluster in accordance with a weight corresponding to each respective machine learning model (step 510). Furthermore, the computer determines a prediction confidence score for the overall prediction of each respective cluster of the predefined number of machine learning model clusters (step 512).

The computer identifies a cluster of machine learning models of the predefined number of machine learning model clusters having a highest prediction confidence score (step 514). The computer utilizes a prediction of the cluster of machine learning models having the highest prediction confidence score as a final prediction for classification of the input data record corresponding to the given problem (step 516). The computer outputs the final prediction for the classification of the input data record corresponding to the given problem associated with the service to the client device via the network (step 518).

Thus, illustrative embodiments of the present invention provide a computer-implemented method, computer system, and computer program product for deploying machine learning models and predicting input data record classification with increased accuracy. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer, a new machine learning model for a given problem that corresponds to a service running in a container of a host node;
selecting, by the computer, a given cluster of machine learning models of a plurality of clusters of machine learning models corresponding to the given problem to form a selected cluster;
determining, by the computer, a cluster performance score for the selected cluster based on combining a model performance score of each respective machine learning model in the selected cluster in accordance with a corresponding weight of each respective machine learning model;
determining, by the computer, whether the cluster performance score of the selected cluster is greater than a predefined minimum cluster performance score threshold level; and
adding, by the computer, the new machine learning model to the selected cluster to increase predictive accuracy for the given problem while the service is running in the container of the host node without interruption of the service in response to the computer determining that the cluster performance score of the selected cluster is greater than the predefined minimum cluster performance score threshold level.

2. The computer-implemented method of claim 1, further comprising:
determining, by the computer, a coefficient value for each respective cluster of machine learning models of the plurality of clusters of machine learning models;
ranking, by the computer, the plurality of clusters of machine learning models in descending order by corresponding coefficient value in a list from a lowest coefficient value cluster to a highest coefficient value cluster; and
selecting, by the computer, the given cluster of machine learning models of the plurality of clusters of machine learning models from the list in the descending order to form the selected cluster.

3. The computer-implemented method of claim 1, further comprising:
receiving, by the computer, a new validation dataset corresponding to the new machine learning model;
combining, by the computer, the new validation dataset corresponding to the new machine learning model with a current validation dataset corresponding to the selected cluster to form a combined validation dataset for the selected cluster;
determining, by the computer, a total number of data records in the combined validation dataset for the selected cluster;
determining, by the computer, whether the total number of data records in the combined validation dataset for the selected cluster is greater than a predefined maximum number of data records for a single validation dataset; and
reducing, by the computer, the total number of data records in the combined validation dataset for the selected cluster to a user-specified number of data records by sampling the total number of data records in the combined validation dataset in response to the computer determining that the total number of data records in the combined validation dataset for the selected cluster is greater than the predefined maximum number of data records for a single validation dataset.

4. The computer-implemented method of claim 3, further comprising:
determining, by the computer, a model performance score for each respective machine learning model in the selected cluster using the combined validation dataset based on a predefined model evaluation metric in response to the computer determining that the total number of data records in the combined validation dataset for the selected cluster is not greater than the predefined maximum number of data records for a single validation dataset;
determining, by the computer, a number of machine learning models in the selected cluster;
determining, by the computer, whether the number of machine learning models in the selected cluster is equal to a predefined maximum number of models for a single cluster of machine learning models;
selecting, by the computer, a machine learning model in the selected cluster that has a lowest model performance score in response to the computer determining that the number of machine learning models in the selected cluster is equal to the predefined maximum number of models for a single cluster of machine learning models; and
determining, by the computer, whether the machine learning model having the lowest model performance score is the new machine learning model.

5. The computer-implemented method of claim 4, further comprising:
determining by the computer, the cluster performance score for the selected cluster based on combining the model performance score of each respective machine learning model in the selected cluster in accordance with the corresponding weight of each respective machine learning model in response to the computer determining that the machine learning model having the lowest model performance score is not the new machine learning model;
determining, by the computer, whether the cluster performance score of the selected cluster is greater than a predefined minimum cluster performance score threshold level;
adding, by the computer, the new machine learning model to the selected cluster to increase the predictive accuracy for the given problem while the service is running in the container of the host node without interruption of the service in response to the computer determining that the cluster performance score of the selected cluster is greater than the predefined minimum cluster performance score threshold level;
replacing, by the computer, the current validation dataset corresponding to the selected cluster with the combined validation dataset; and
recalculating, by the computer, the corresponding weight of respective machine learning models in the selected cluster based on the combined validation dataset.

6. The computer-implemented method of claim 5, further comprising:
removing, by the computer, the machine learning model having the lowest model performance score from the selected cluster to form a removed machine learning model because adding the new machine learning model to the selected cluster caused the number of machine learning models in the selected cluster to exceed a maximum number of machine learning models for a single cluster of machine learning models.

7. The computer-implemented method of claim 6, further comprising:
determining, by the computer, whether all of the plurality of clusters of machine learning models have been selected;
determining, by the computer, that a remaining machine learning model exits in response to the computer determining that all of the plurality of clusters of machine learning models have been selected, wherein the remaining machine learning model is one of the new machine learning model or the removed machine learning model;
determining, by the computer, a total number of clusters in the plurality of clusters of machine learning models;
determining, by the computer, whether the total number of clusters is less than a predefined maximum number of machine learning model clusters and the model performance score of the remaining machine learning model is greater than a predefined minimum model performance score threshold level based on a corresponding validation dataset of the remaining machine learning model; and
sending, by the computer, an alert regarding the remaining machine learning model to a user indicating one of a warning when the remaining machine learning model is the removed machine learning model because its model performance score is less than the new machine learning model and the predefined maximum number of machine learning model clusters has been reached or an error when the remaining machine learning model is the new machine learning model because its model performance score is less than any existing machine learning model and the predefined maximum number of machine learning model clusters has been reached in response to the computer determines that one of the total number of clusters is not less than the predefined maximum number of machine learning model clusters or the model performance score of the remaining machine learning model is not greater than the predefined minimum model performance score threshold level based on the corresponding validation dataset of the remaining machine learning model.

8. The computer-implemented method of claim 7, further comprising:
adding, by the computer, a new cluster to the plurality of clusters of machine learning models in response to the computer determining that the total number of clusters is less than the predefined maximum number of machine learning model clusters and the model performance score of the remaining machine learning model is greater than the predefined minimum model performance score threshold level based on the corresponding validation dataset of the remaining machine learning model;
adding, by the computer, the remaining machine learning model to the new cluster; and
assigning, by the computer, a default weight to the remaining machine learning model added to the new cluster.

9. The computer-implemented method of claim 1, further comprising:
receiving, by the computer, an input data record having all values for all input fields corresponding to the given problem associated with the service from a client device via a network;
traversing, by the computer, the plurality of clusters of machine learning models corresponding to the given problem to identify a center of a validation dataset of each respective cluster of machine learning models of the plurality of clusters of machine learning models;
determining, by the computer, a distance between the input data record and the center of the validation dataset of each respective cluster of machine learning models of the plurality of clusters of machine learning models;
selecting, by the computer, a predefined number of machine learning model clusters having a shortest distance between the input data record and the center of the validation dataset of each of the predefined number of machine learning model clusters; and
determining, by the computer, an overall prediction of each respective cluster of the predefined number of machine learning model clusters for the input data record corresponding to the given problem based on combining a predictive output of each respective machine learning model in each respective cluster in accordance with the corresponding weight of each respective machine learning model.

10. The computer-implemented method of claim 9, further comprising:
determining, by the computer, a prediction confidence score for the overall prediction of each respective cluster of the predefined number of machine learning model clusters;
identifying, by the computer, a cluster of machine learning models of the predefined number of machine learning model clusters having a highest prediction confidence score;
utilizing, by the computer, a prediction of the cluster of machine learning models having the highest prediction confidence score as a final prediction for classification of the input data record corresponding to the given problem; and
outputting, by the computer, the final prediction for the classification of the input data record corresponding to the given problem associated with the service to the client device via the network.

11. A computer system comprising:
a communication fabric;
a storage device connected to the communication fabric, wherein the storage device stores program instructions; and
a processor connected to the communication fabric, wherein the processor executes the program instructions to:
receive a new machine learning model for a given problem that corresponds to a service running in a container of a host node;
select a given cluster of machine learning models of a plurality of clusters of machine learning models corresponding to the given problem to form a selected cluster;
determine a cluster performance score for the selected cluster based on combining a model performance score of each respective machine learning model in the selected cluster in accordance with a corresponding weight of each respective machine learning model;
determine whether the cluster performance score of the selected cluster is greater than a predefined minimum cluster performance score threshold level; and
add the new machine learning model to the selected cluster to increase predictive accuracy for the given problem while the service is running in the container of the host node without interruption of the service in response to determining that the cluster performance score of the selected cluster is greater than the predefined minimum cluster performance score threshold level.

12. The computer system of claim 11, wherein the processor further executes the program instructions to:
determine a coefficient value for each respective cluster of machine learning models of the plurality of clusters of machine learning models;
rank the plurality of clusters of machine learning models in descending order by corresponding coefficient value in a list from a lowest coefficient value cluster to a highest coefficient value cluster; and
select the given cluster of machine learning models of the plurality of clusters of machine learning models from the list in the descending order to form the selected cluster.

13. The computer system of claim 11, wherein the processor further executes the program instructions to:
receive a new validation dataset corresponding to the new machine learning model;
combine the new validation dataset corresponding to the new machine learning model with a current validation dataset corresponding to the selected cluster to form a combined validation dataset for the selected cluster;
determine a total number of data records in the combined validation dataset for the selected cluster;
determine whether the total number of data records in the combined validation dataset for the selected cluster is greater than a predefined maximum number of data records for a single validation dataset; and
reduce the total number of data records in the combined validation dataset for the selected cluster to a user-specified number of data records by sampling the total number of data records in the combined validation dataset in response to determining that the total number of data records in the combined validation dataset for the selected cluster is greater than the predefined maximum number of data records for a single validation dataset.

14. The computer system of claim 13, wherein the processor further executes the program instructions to:
determine a model performance score for each respective machine learning model in the selected cluster using the combined validation dataset based on a predefined model evaluation metric in response to determining that the total number of data records in the combined validation dataset for the selected cluster is not greater than the predefined maximum number of data records for a single validation dataset;
determine a number of machine learning models in the selected cluster;
determine whether the number of machine learning models in the selected cluster is equal to a predefined maximum number of models for a single cluster of machine learning models;
select a machine learning model in the selected cluster that has a lowest model performance score in response to determining that the number of machine learning models in the selected cluster is equal to the predefined maximum number of models for a single cluster of machine learning models; and
determine whether the machine learning model having the lowest model performance score is the new machine learning model.

15. The computer system of claim 14, wherein the processor further executes the program instructions to:
determine the cluster performance score for the selected cluster based on combining the model performance score of each respective machine learning model in the selected cluster in accordance with the corresponding weight of each respective machine learning model in response to determining that the machine learning model having the lowest model performance score is not the new machine learning model;
determine whether the cluster performance score of the selected cluster is greater than a predefined minimum cluster performance score threshold level;
add the new machine learning model to the selected cluster to increase the predictive accuracy for the given problem while the service is running in the container of the host node without interruption of the service in response to determining that the cluster performance score of the selected cluster is greater than the predefined minimum cluster performance score threshold level;
replace the current validation dataset corresponding to the selected cluster with the combined validation dataset; and
recalculate the corresponding weight of respective machine learning models in the selected cluster based on the combined validation dataset.

16. A computer program product comprising a computer-readable storage medium having program instructions embodied therewith, the program instructions executable by a computer to cause the computer to perform a method of:
receiving, by the computer, a new machine learning model for a given problem that corresponds to a service running in a container of a host node;
selecting, by the computer, a given cluster of machine learning models of a plurality of clusters of machine learning models corresponding to the given problem to form a selected cluster;
determining, by the computer, a cluster performance score for the selected cluster based on combining a model performance score of each respective machine learning model in the selected cluster in accordance with a corresponding weight of each respective machine learning model;
determining, by the computer, whether the cluster performance score of the selected cluster is greater than a predefined minimum cluster performance score threshold level; and
adding, by the computer, the new machine learning model to the selected cluster to increase predictive accuracy for the given problem while the service is running in the container of the host node without interruption of the service in response to the computer determining that the cluster performance score of the selected cluster is greater than the predefined minimum cluster performance score threshold level.

17. The computer program product of claim 16, further comprising:
determining, by the computer, a coefficient value for each respective cluster of machine learning models of the plurality of clusters of machine learning models;
ranking, by the computer, the plurality of clusters of machine learning models in descending order by corresponding coefficient value in a list from a lowest coefficient value cluster to a highest coefficient value cluster; and
selecting, by the computer, the given cluster of machine learning models of the plurality of clusters of machine learning models from the list in the descending order to form the selected cluster.

18. The computer program product of claim 16, further comprising:
receiving, by the computer, a new validation dataset corresponding to the new machine learning model;
combining, by the computer, the new validation dataset corresponding to the new machine learning model with a current validation dataset corresponding to the selected cluster to form a combined validation dataset for the selected cluster;
determining, by the computer, a total number of data records in the combined validation dataset for the selected cluster;
determining, by the computer, whether the total number of data records in the combined validation dataset for the selected cluster is greater than a predefined maximum number of data records for a single validation dataset; and
reducing, by the computer, the total number of data records in the combined validation dataset for the selected cluster to a user-specified number of data records by sampling the total number of data records in the combined validation dataset in response to the computer determining that the total number of data records in the combined validation dataset for the selected cluster is greater than the predefined maximum number of data records for a single validation dataset.

19. The computer program product of claim 18, further comprising:
determining, by the computer, a model performance score for each respective machine learning model in the selected cluster using the combined validation dataset based on a predefined model evaluation metric in response to the computer determining that the total number of data records in the combined validation dataset for the selected cluster is not greater than the predefined maximum number of data records for a single validation dataset;
determining, by the computer, a number of machine learning models in the selected cluster;
determining, by the computer, whether the number of machine learning models in the selected cluster is equal to a predefined maximum number of models for a single cluster of machine learning models;
selecting, by the computer, a machine learning model in the selected cluster that has a lowest model performance score in response to the computer determining that the number of machine learning models in the selected cluster is equal to the predefined maximum number of models for a single cluster of machine learning models; and
determining, by the computer, whether the machine learning model having the lowest model performance score is the new machine learning model.

20. The computer program product of claim 19, further comprising:
determining by the computer, the cluster performance score for the selected cluster based on combining the model performance score of each respective machine learning model in the selected cluster in accordance with the corresponding weight of each respective machine learning model in response to the computer determining that the machine learning model having the lowest model performance score is not the new machine learning model;
determining, by the computer, whether the cluster performance score of the selected cluster is greater than a predefined minimum cluster performance score threshold level;
adding, by the computer, the new machine learning model to the selected cluster to increase the predictive accuracy for the given problem while the service is running in the container of the host node without interruption of the service in response to the computer determining that the cluster performance score of the selected cluster is greater than the predefined minimum cluster performance score threshold level;
replacing, by the computer, the current validation dataset corresponding to the selected cluster with the combined validation dataset; and
recalculating, by the computer, the corresponding weight of respective machine learning models in the selected cluster based on the combined validation dataset.
